(19) United States
(12) Patent Application Publication
(10) Pub. No.: US 2016/0371528 A1
(43) Pub. Date: Dec. 22, 2016

(54) CONCEALED FINGERPRINT SENSOR WITH WAKE-UP AND ELECTROSTATIC DISCHARG

(71) Applicant: Motorola Mobility LLC, Chicago, IL (US)

(72) Inventors: Jiri Slaby, Buffalo Grove, IL (US); Justin Eltoft, Pleasant Prairie, WI (US); Lawrence A. Willis, Dubuque, IA (US)

(21) Appl. No.: 14/741,585

(22) Filed: Jun. 17, 2015

(51) Int. Cl. G06K 9/00; G06F 3/0484; G06F 3/0482; G06F 21/32; G06F 1/32

(52) U.S. Cl. CPC G06K 9/0002; G06K 9/0012; G06F 21/32; G06F 1/3231; G06F 3/0482; G06F 3/04842

(57) ABSTRACT

In embodiments of a concealed fingerprint sensor with wake-up and electrostatic discharge, a mobile device includes the fingerprint sensor for user authentication to the mobile device, such as concealed under a non-conductive surface that also covers an integrated display of the mobile device. A conductive metal formed as micro-vias extend through the non-conductive surface, where the micro-vias discharge the electrostatic energy of a user of the mobile device when the user contacts the micro-vias, such as when placing a finger on the non-conductive surface over the fingerprint sensor. Additionally, the fingerprint sensor can be implemented to activate based on a conductive signal that is generated when the electrostatic energy of the user is discharged, and the fingerprint sensor wakes-up to image a fingerprint of the user for authentication.

### BACKGROUND

Portable devices, such as mobile phones, tablet devices, digital cameras, and other types of computing and electronic devices can include a fingerprint sensor that a user can simply touch with a thumb or finger to access a device. A fingerprint sensor is typically positioned in a bezel area around the integrated display of a mobile device, and the display lens that covers the display extends over the bezel area around the display. However, the display lens is designed with an opening to accommodate access to the fingerprint sensor so that a user can place a thumb or finger on the sensor, which then images the fingerprint for user authentication. Further, a fingerprint sensor needs to first be activated to image the fingerprint, such as requiring the user to initiate a device on-button, or other type of activation of the device, which then initiates activation of the fingerprint sensor. This type of sensor activation can include “wake on finger touch” to “wake-up” the fingerprint sensor, which requires the sensor to always be in a powered or semi-powered state monitoring for a sensor touch. This can contribute to drain the battery or other power source of a portable device. Additionally, a user may simply touch the sensor area without picking up or otherwise touching the device. The user may not be grounded to dissipate any electrostatic energy when simply touching the sensor area, and thus, the metal housing of a device cannot be solely relied on for electrostatic discharge.

### BRIEF DESCRIPTION OF THE DRAWINGS

Embodiments of a concealed fingerprint sensor with wake-up and electrostatic discharge are described with reference to the following Figures. The same numbers may be used throughout to reference like features and components that are shown in the Figures:

FIG. 1 illustrates an example mobile device in which embodiments of a concealed fingerprint sensor with wake-up and electrostatic discharge can be implemented.

FIG. 2 further illustrates examples of a concealed fingerprint sensor with wake-up and electrostatic discharge in accordance with one or more embodiments.

FIG. 3 illustrates an example method of a concealed fingerprint sensor with wake-up and electrostatic discharge in accordance with one or more embodiments.

FIG. 4 illustrates another example method of a concealed fingerprint sensor with wake-up and electrostatic discharge in accordance with one or more embodiments.

FIG. 5 illustrates various components of an example device that can implement embodiments of a concealed fingerprint sensor with wake-up and electrostatic discharge.

### DETAILED DESCRIPTION

Embodiments of a concealed fingerprint sensor with wake-up and electrostatic discharge are described, such as for any type of mobile device that may be implemented with a fingerprint sensor system that is utilized to authenticate a user and unlock a mobile device for use. Additionally, there is also a growing trend for many device applications to generate a multitude of notifications that are displayed on a lock screen of a device, and the notifications tend to clutter the display and generally contribute to user information overload. Accordingly, some users wish to disable or minimize the barrage of notifications.

In implementations, a mobile device includes the fingerprint sensor for user authentication to the mobile device, such as concealed under a non-conductive surface that also covers an integrated display of the mobile device. A conductive metal formed as micro-vias extend through the non-conductive surface, where the micro-vias discharge the electrostatic energy of a user of the mobile device when the user contacts the micro-vias, such as when placing a thumb of finger on the non-conductive surface over the fingerprint sensor. Additionally, the fingerprint sensor can be implemented to activate based on a conductive signal that is generated when the electrostatic energy of the user is discharged, and the fingerprint sensor wakes-up to image a fingerprint of the user for authentication. This aspect provides that the fingerprint sensor can be maintained in an ultra, low-power state with little to no drain on the battery or other power source of the mobile device, rather than in an active state always monitoring for a sensor touch. Additionally, the conductive path of the micro-vias can serve as a technique to verify that a finger touch is not fake (e.g., the “live-ness” of an authentication attempt by a live person using the fingerprint sensor). Further, a user can touch select one of the many displayed notifications to initiate displaying the full context of the notification, and when authenticated, the mobile device displays the full context of the notification. Alternatively, the user of a mobile device may simply wish to authenticate to unlock the device and bypass viewing any of the notifications.

While features and concepts of a concealed fingerprint sensor with wake-up and electrostatic discharge can be implemented in any number of different devices, systems, environments, and/or configurations, embodiments of a concealed fingerprint sensor with wake-up and electrostatic discharge are described in the context of the following example devices, systems, and methods.

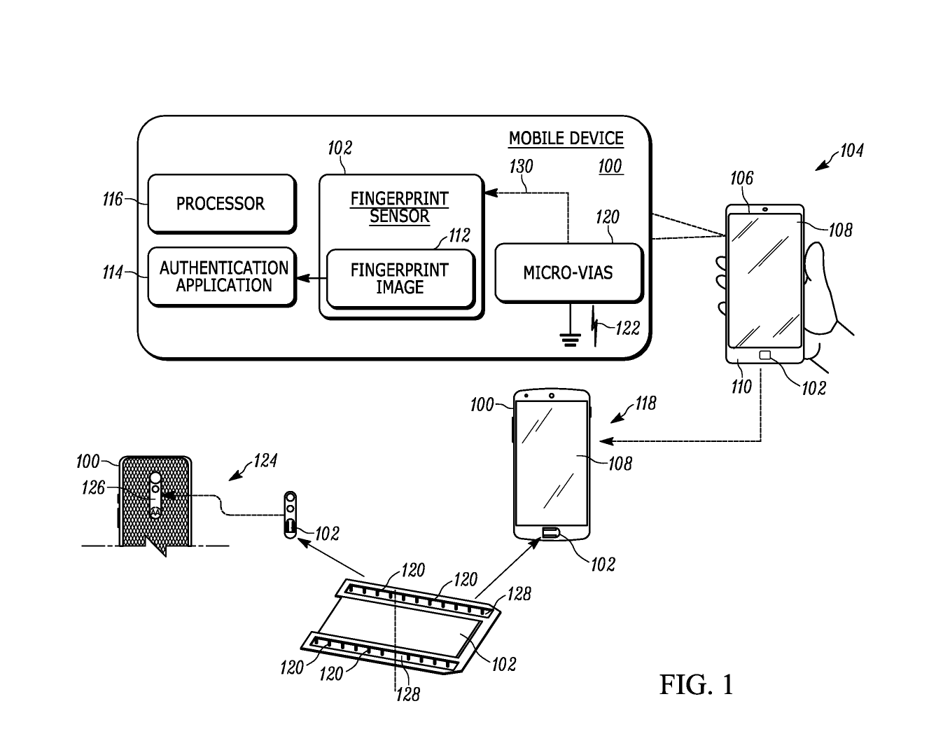

FIG. 1 illustrates an example mobile device 100 in which embodiments of a concealed fingerprint sensor with wake-up and electrostatic discharge can be implemented. The example mobile device 100 may be any type of mobile phone, tablet device, digital camera, or other types of computing and electronic devices that are typically battery powered. In this example, the mobile device 100 implements components and features of a fingerprint sensor 102 that can be utilized by a user of the mobile device for authentication to access and use the device. As shown at 104, the mobile device 100 includes an integrated display 106 and a non-conductive surface 108, such as a glass surface, over the integrated display of the mobile device. As an alternative to glass, the non-conductive surface 108 may be a ceramic, plastic, fabric, or other type of non-conductive material. In this example, the fingerprint sensor 102 is shown positioned in a bezel area 110 around the integrated display 106 of the mobile device, and the non-conductive surface 108 that covers the integrated display 106 also extends over the bezel area 110 and over the fingerprint sensor.

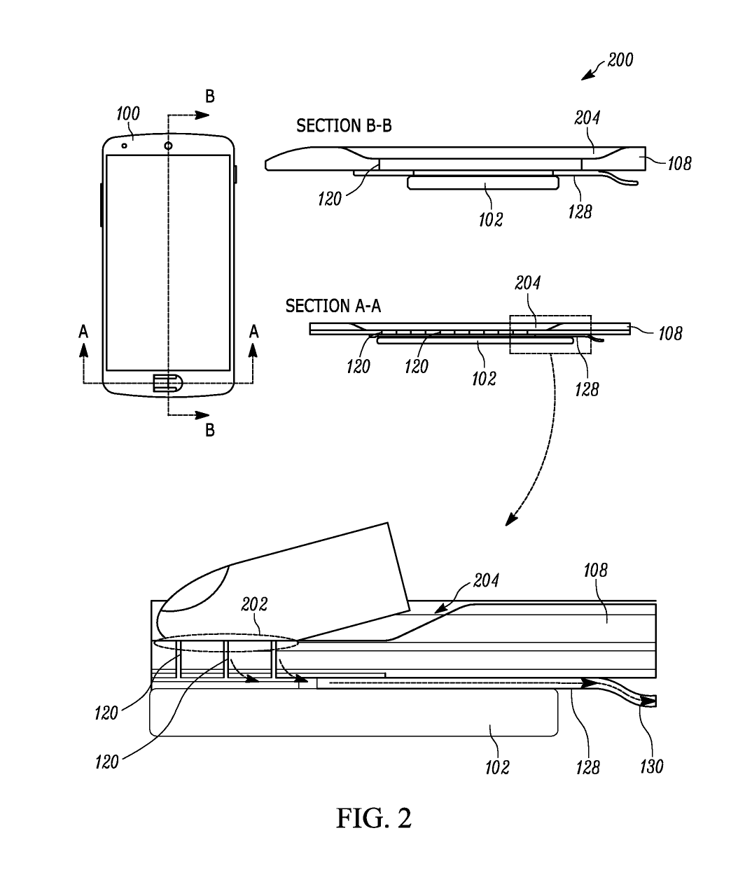

The fingerprint sensor 102 is shown with a dashed line to indicate the location of the fingerprint sensor, which may be otherwise hidden under the non-conductive surface 108. Additionally, the housing of the mobile device 100 may include a recessed region that a user can feel to locate the position of the fingerprint sensor (e.g., a recessed region in which to place a thumb or finger for fingerprint authentication). This is further shown in cross-sections of the mobile device 100 that are described with reference to FIG. 2. For example, a user can pick up the mobile device 100 and place a thumb or finger on the non-conductive surface 108 over the location of the fingerprint sensor 102 for authentication to use the device. The fingerprint sensor 102 can generate a fingerprint image 112 of a fingerprint, and an authentication application 114 can then authenticate the user to the mobile device based on the fingerprint image.

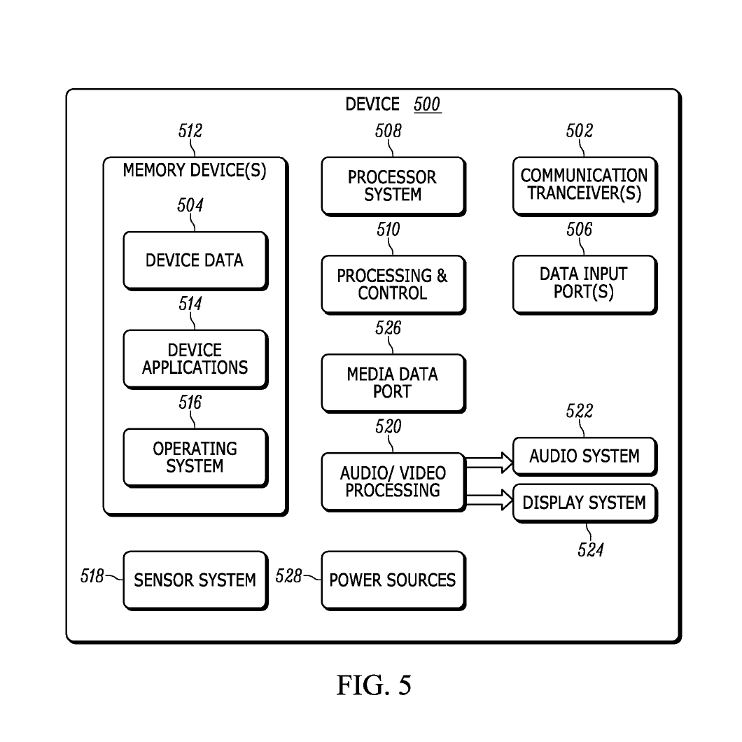

The authentication application 114 can be implemented as a software application or module, such as executable software instructions (e.g., computer-executable instructions) that are executable with a processor 116 of the device. Further, the authentication application 114 can be stored on computer-readable storage memory (e.g., a memory device), such as any suitable memory device or electronic data storage implemented in the mobile device. Additionally, the mobile device 100 can be implemented with various components, such as a processing system and memory, and any number and combination of various components as further described with reference to the example device shown in FIG. 5.

As shown in an example 118, the fingerprint sensor 102 of the mobile device 100 can be positioned under the non-conductive surface 108 in a configuration that includes micro-vias 120, which extend and are exposed through the non-conductive surface 108 for user contact when a user of the device initiates authentication with the fingerprint sensor. When a user of the device places a thumb or finger over the fingerprint sensor 102 for authentication to use the device, the user contacts the micro-vias 120, which form a conductive path and serve to discharge electrostatic energy 122 of the user. The micro-vias 120 are formed with any type of conductive metal through the non-conductive surface 108, and on contact, the conductive metal grounds the user of the mobile device and discharges the electrostatic energy. Additionally, the conductive path of the micro-vias can serve as a technique to verify that a finger touch is not fake (e.g., the “live-ness” of an authentication attempt by a live person using the fingerprint sensor). Although the fingerprint sensor 102 is shown exposed merely for the illustrative example 118, in implementations, the fingerprint sensor 102 can be concealed under the non-conductive surface 108 and/or under decorative coverings. In another example implementation shown at 124, the fingerprint sensor 102 can be integrated under a rear bezel 126 of the device housing, along with the imager (e.g., camera device and LED for illumination).

The micro-vias 120 are connected to a flexible conductor 128 (commonly referred to as a “flex trace”) that provides a conductive path to ground the electrostatic energy from the user. The flexible conductor 128 can be integrated with the fingerprint sensor 102 as shown, or may be configured within the device independent of the fingerprint sensor. Further, the micro-vias 120 and the flexible conductor 128 may be located on the two sides of the fingerprint sensor (as shown), or may be configured on four sides around the fingerprint sensor. In alternative implementations of the flexible conductor 128, the micro-vias 120 can be connected to a solid PCB, a rigid flex PCB, or a solid metal incorporated on either a flex or rigid PCB. In embodiments, the micro-vias 120 discharge the electrostatic energy of a user when the user contacts the micro-vias. Additionally, a conductive signal 130 is generated, which can be utilized as a wake-up signal to initiate the fingerprint sensor, wake-up the processor 116, and/or used to initiate any other sensors or features of the mobile device. The fingerprint sensor 102 can be activated based on the conductive signal 130 that is generated when the electrostatic energy 122 of the user is discharged.

FIG. 2 illustrates cross-section examples 200 of the mobile device 100 in embodiments of a concealed fingerprint sensor with wake-up and electrostatic discharge as described herein. The example cross-sections illustrate the fingerprint sensor 102, the micro-vias 120 that extend through the material forming the non-conductive surface 108, and the flexible conductor 128 that connects the micro-vias to provide a conductive path to ground the electrostatic energy from a user of the device during user contact 202 with the micro-vias. The flexible conductor 128 also provides the path for the conductive signal 130, which can be utilized as a wake-up signal to initiate the fingerprint sensor 102, wake-up the processor 116, and/or used to initiate any other sensors or features of the mobile device. The example cross-sections also illustrate a recess 204, which is a recessed region in the device housing that a user can feel to locate the position of the fingerprint sensor, and in which to place a thumb or finger for fingerprint authentication.

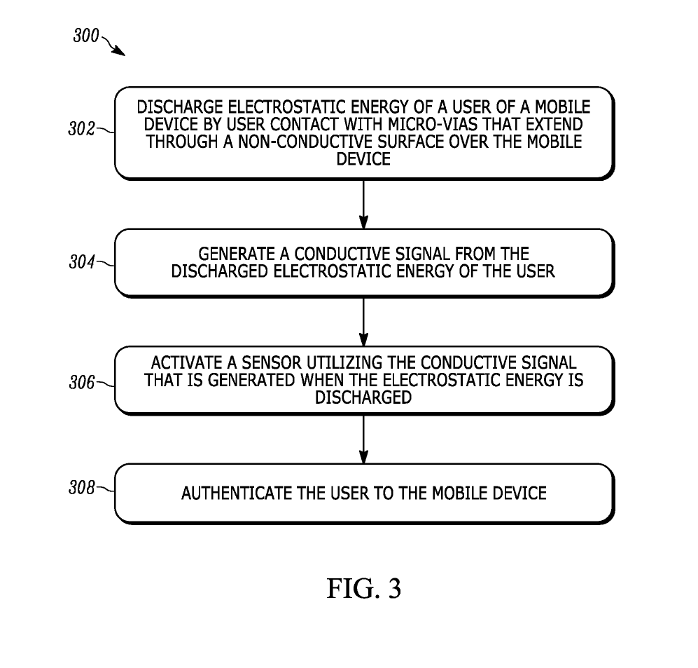

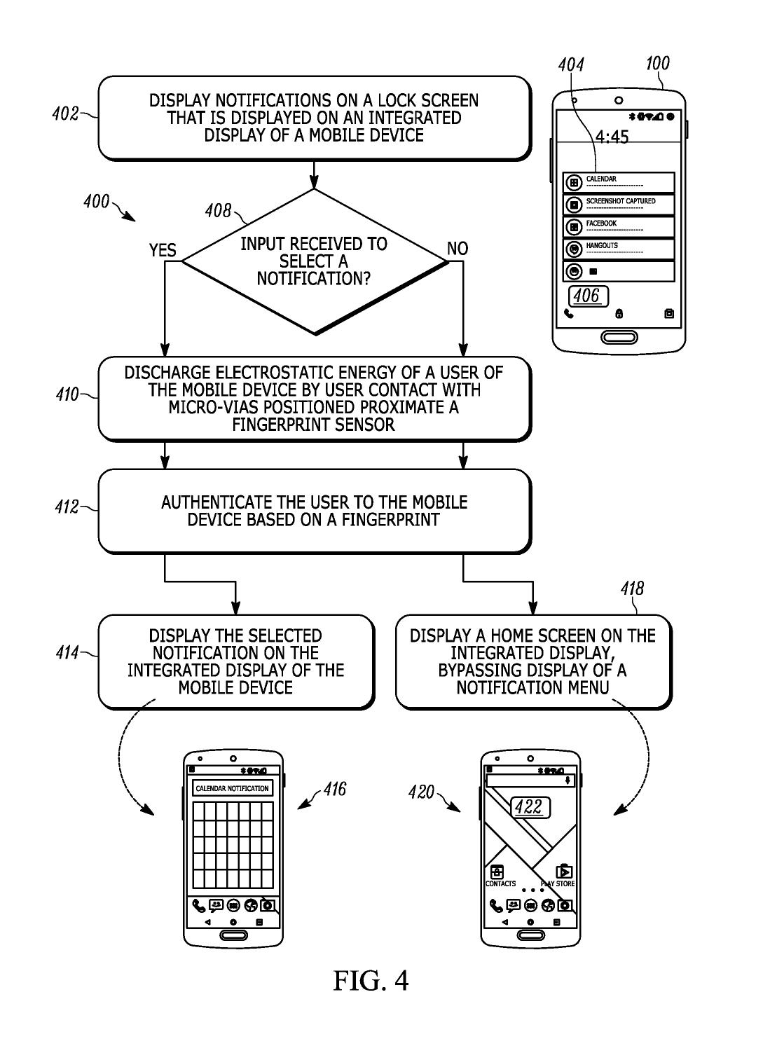

Example methods 300 and 400 are described with reference to respective FIGS. 3 and 4 in accordance with implementations of a concealed fingerprint sensor with wake-up and electrostatic discharge. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory device that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of concealed fingerprint sensor with wake-up and electrostatic discharge. The order in which the method is described is not intended to be construed as a limitation, and any number or combination of the described method operations can be performed in any order to perform a method, or an alternate method.

At 302, electrostatic energy of a user of a mobile device is discharged by user contact with micro-vias that extend through a non-conductive surface over the mobile device. For example, the micro-vias 120 shown in FIGS. 1 and 2 extend and are exposed through the non-conductive surface 108 of the mobile device 100 for user contact when a user of the device initiates authentication with the fingerprint sensor 102. When a user of the device places a thumb or finger over the fingerprint sensor 102 for authentication to use the device, the user contacts the micro-vias 120, which form a conductive path and serve to discharge the electrostatic energy 122 of the user. The micro-vias 120 are formed with any type of conductive metal through the non-conductive surface 108, and on contact, the conductive metal grounds the user of the mobile device and discharges the electrostatic energy.

At 304, a conductive signal is generated from the discharged electrostatic energy of the user. For example, the micro-vias 120 discharge the electrostatic energy of a user when the user contacts the micro-vias and the conductive signal 130 is generated, which can be utilized as a wake-up signal to initiate the fingerprint sensor 102, wake-up the processor 116, and/or used to initiate any other sensors or features of the mobile device. Additionally, the conductive signal can be used to verify that a finger touch is not fake (e.g., the “live-ness” of an authentication attempt by a live person using the fingerprint sensor).

At 306, a sensor is activated utilizing the conductive signal that is generated when the electrostatic energy is discharged. For example, the fingerprint sensor 102 is activated based on the conductive signal 130 that is generated when the electrostatic energy 122 of the user is discharged, and the fingerprint sensor is activated for user authentication to the mobile device.

At 308, the user is authenticated to the mobile device. For example, the user can place a thumb or finger on the non-conductive surface 108 over the location of the fingerprint sensor 102 for authentication to use the mobile device 100. The fingerprint sensor 102 generates the fingerprint image 112 of a fingerprint, and the authentication application 114 then authenticates the user to the mobile device based on the fingerprint image.

FIG. 4 illustrates example method(s) 400 of concealed fingerprint sensor with wake-up and electrostatic discharge. The order in which the method is described is not intended to be construed as a limitation, and any number or combination of the described method operations can be performed in any order to perform a method, or an alternate method.

At 402, notifications are displayed on a lock screen that is displayed on an integrated display of a mobile device. For example, multiple notifications 404 from various device applications, such as a calendar, weather, social media, email, text, and any other type of device application can generate a notification that is displayed in a lock screen 406 on the integrated display 106 of the mobile device 100.

At 408, a determination is made as to whether an input is received to select one of the displayed notifications. For example, a user of the mobile device 100 can touch select one of the displayed notifications 404 to initiate displaying the full context of the notification in the associated application on the integrated display 106 of the mobile device 100. Given that the mobile device 100 is locked to prevent unauthorized access, the user of the device is authenticated prior to displaying the full context of the notification (i.e., “Yes” from 408). Alternatively, the user of the mobile device 100 may simply wish to unlock the device and bypass viewing any of the notifications (i.e., “No” from 408).

At 410, electrostatic energy of a user of the mobile device is discharged by user contact with micro-vias positioned proximate a fingerprint sensor. For example, the micro-vias 120 shown in FIGS. 1 and 2 extend and are exposed through the non-conductive surface 108 of the mobile device 100 for user contact when a user of the device initiates authentication with the fingerprint sensor 102. When a user of the device places a thumb or finger over the fingerprint sensor 102 for authentication to unlock and use the device, the user contacts the micro-vias 120, which form a conductive path and serve to discharge the electrostatic energy 122 of the user.

At 412, the user is authenticated to the mobile device based on a fingerprint. For example, the fingerprint sensor 102 generates the fingerprint image 112 of a fingerprint of the user, and the authentication application 114 then authenticates the user to the mobile device based on the fingerprint image.

If a user input is received to select one of the displayed notifications (i.e., “Yes” from 408), then at 414, the selected notification is displayed on the integrated display of the mobile device. For example, as shown at 416, a user of the mobile device 100 can touch select one of the displayed notifications 404 to initiate displaying the full context of the notification in the associated application on the integrated display 106 of the mobile device 100.

If a user input is not received to select one of the displayed notifications (i.e., “No” from 408), then at 418, a home screen is displayed on the integrated display of the mobile device, bypassing display of a notification menu. For example, as shown at 420, a home screen 422 is displayed on the integrated display 106 of the mobile device 100, bypassing display of a notification menu after authenticating the user for use of the mobile device.

FIG. 5 illustrates various components of an example device 500 in which embodiments of concealed fingerprint sensor with wake-up and electrostatic discharge can be implemented. The example device 500 can be implemented as any of the computing devices described with reference to the previous FIGS. 1-4, such as any type of client device, mobile phone, tablet, computing, communication, entertainment, gaming, media playback, and/or other type of device. For example, the mobile device 100 shown in FIG. 1 may be implemented as the example device 500.

The device 500 includes communication transceivers 502 that enable wired and/or wireless communication of device data 504 with other devices. Additionally, the device data can include any type of audio, video, and/or image data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

The device 500 may also include one or more data input ports 506 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 500 includes a processing system 508 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 510. The device 500 may further include any type of a system bus or other data and command transfer system that couples the various components within the device. A system bus can include any one or combination of different bus structures and architectures, as well as control and data lines.

The device 500 also includes computer-readable storage memory 512 that enable data storage, such as data storage devices that can be accessed by a computing device, and that provide persistent storage of data and executable instructions (e.g., software applications, programs, functions, and the like). Examples of the computer-readable storage memory 512 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 500 may also include a mass storage media device.

The computer-readable storage memory 512 provides data storage mechanisms to store the device data 504, other types of information and/or data, and various device applications 514 (e.g., software applications). For example, an operating system 516 can be maintained as software instructions with a memory device and executed by the processing system 508. The device applications may also include a device manager, such as any form of a control application, software application, signal-processing and control module, code that is native to a particular device, a hardware abstraction layer for a particular device, and so on. In this example, the device 500 includes a sensor system 518 that implements embodiments of a concealed fingerprint sensor with wake-up and electrostatic discharge, and may be implemented with hardware components and/or in software, such as when the device 500 is implemented as the mobile device 100 described with reference to FIGS. 1-4. An example of the sensor system 518 is the fingerprint sensor 102, micro-vias 120, and the authentication application 114 that are implemented by the mobile device 100.

The device 500 also includes an audio and/or video processing system 520 that generates audio data for an audio system 522 and/or generates display data for a display system 524. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 526. In implementations, the audio system and/or the display system are integrated components of the example device. Alternatively, the audio system and/or the display system are external, peripheral components to the example device.

The device 500 can also include one or more power sources 528, such as when the device is implemented as a mobile device. The power sources may include a charging and/or power system, and can be implemented as a flexible strip battery, a rechargeable battery, a charged super-capacitor, and/or any other type of active or passive power source.

Although embodiments of a concealed fingerprint sensor with wake-up and electrostatic discharge have been described in language specific to features and/or methods, the subject of the appended claims is not necessarily limited to the specific features or methods described. Rather, the specific features and methods are disclosed as example implementations of a concealed fingerprint sensor with wake-up and electrostatic discharge, and other equivalent features and methods are intended to be within the scope of the appended claims. Further, various different embodiments are described and it is to be appreciated that each described embodiment can be implemented independently or in connection with one or more other described embodiments.

1. A method for sensor wake-up and electrostatic discharge, the method comprising:
discharging electrostatic energy of a user of a mobile device, the electrostatic energy being discharged by user contact with micro-vias that extend through a non-conductive surface over the mobile device; and
activating a sensor based on a conductive signal that is generated when said discharging the electrostatic energy of the user.

2. The method as recited in claim 1, further comprising grounding the user of the mobile device based on said discharging the electrostatic energy, and wherein the user contact with the micro-vias is verifiable as contact from a live person based on the conductive signal that is generated.

3. The method as recited in claim 1, wherein the micro-vias are a conductive metal formed through the non-conductive surface, the conductive metal configured to ground the user of the mobile device and said discharge the electrostatic energy.

4. The method as recited in claim 1, further comprising waking-up a processor of the mobile device based on the conductive signal.

5. The method as recited in claim 1, wherein the non-conductive surface covers an integrated display of the mobile device, and the non-conductive surface is one of glass, plastic, or a ceramic.

6. The method as recited in claim 1, wherein the sensor is a fingerprint sensor, and said activating the fingerprint sensor based on the conductive signal, the fingerprint sensor activated for user authentication to the mobile device.

7. The method as recited in claim 6, further comprising:
displaying notifications on a lock screen that is displayed on an integrated display of the mobile device;
authenticating the user based on a fingerprint; and
displaying a home screen on the integrated display, bypassing display of a notification menu after said authenticating the user.

8. The method as recited in claim 6, further comprising:
displaying notifications on a lock screen that is displayed on an integrated display of the mobile device;
receiving an input selecting one of the displayed notifications;
authenticating the user based on a fingerprint; and
displaying the selected notification on the integrated display of the mobile device.

9. A mobile device, comprising:
an integrated display configured to display application interfaces;
a non-conductive surface configured over the integrated display of the mobile device;
micro-vias that extend through the non-conductive surface, the micro-vias configured to discharge electrostatic energy of a user of the mobile device, the electrostatic energy discharged by user contact with the micro-vias; and
a fingerprint sensor configured for user authentication to the mobile device, the fingerprint sensor configured to activate based on a conductive signal that is generated when the electrostatic energy of the user is discharged.

10. The mobile device as recited in claim 9, wherein the micro-vias ground the user of the mobile device based on the user contact with the vias, and wherein the user contact with the micro-vias is verifiable as contact from a live person based on the conductive signal that is generated.

11. The mobile device as recited in claim 9, wherein the micro-vias are a conductive metal formed through the non-conductive surface, the conductive metal configured to ground the user of the mobile device and discharge the electrostatic energy.

12. The mobile device as recited in claim 9, further comprising a processor that is configured to wake-up based on the conductive signal that is generated when the electrostatic energy of the user is discharged.

13. The mobile device as recited in claim 9, wherein the non-conductive surface covers the integrated display of the mobile device, and the non-conductive surface is one of glass, plastic, or a ceramic.

14. The mobile device as recited in claim 9, wherein:
the application interfaces include lock screen and a home screen of the mobile device;
the integrated display is configured to display notifications on the lock screen prior to the user authentication to the mobile device, and display a home screen after the user authentication, bypassing display of a notification menu.

15. The mobile device as recited in claim 9, wherein the integrated display is configured to:
display notifications on the lock screen prior to the user authentication to the mobile device;
receive an input to select one of the notifications prior to the user authentication; and
display the selected notification after the user authentication.

16. A system, comprising:
a fingerprint sensor configured to image a fingerprint of a user for user authentication;
a non-conductive surface configured over the fingerprint sensor; and
micro-vias that extend through the non-conductive surface, the micro-vias configured to discharge electrostatic energy based on user contact with the micro-vias.

17. The system as recited in claim 16, wherein the micro-vias are a conductive metal formed through the non-conductive surface, the conductive metal configured to ground the user of a mobile device and discharge the electrostatic energy.

18. The system as recited in claim 16, wherein the fingerprint sensor is configured to activate based on a conductive signal that is generated when the electrostatic energy is discharged.

19. The system as recited in claim 18, wherein the conductive signal that is generated when the electrostatic energy is discharged is utilized to wake-up a processor of a mobile device.

20. The system as recited in claim 16, wherein the non-conductive surface is one of glass, plastic, or a ceramic having the micro-vias that extend through for the user contact.
